(19) United States
(12) Patent Application Publication
(10) Pub. No.: US 2014/0298395 A1
(43) Pub. Date: Oct. 2, 2014

(54) METHODS AND SYSTEMS FOR PLAYING VIDEO ON MULTIPLE TERMINALS

(71) Applicant: TENCENT TECHNOLOGY (SHENZHEN) COMPANY LIMITED, Shenzhen (CN)

(72) Inventors: HUIJIAO YANG, Shenzhen (CN); BO HU, Shenzhen (CN); ZHIPEI WANG, Shenzhen (CN); RUIYI ZHOU, Shenzhen (CN); XI WANG, Shenzhen (CN); KAI ZHANG, Shenzhen (CN); XIN QING, Shenzhen (CN); YING HUANG, Shenzhen (CN); YULEI LIU, Shenzhen (CN); WEI LI, Shenzhen (CN); CHENG PING, Shenzhen (CN)

(73) Assignee: TENCENT TECHNOLOGY (SHENZHEN) COMPANY LIMITED, Shenzhen (CN)

(21) Appl. No.: 14/164,251

(22) Filed: Jan. 26, 2014

Related U.S. Application Data
(63) Continuation of application No. PCT/CN2013/086619, filed on Nov. 6, 2013.

(30) Foreign Application Priority Data
Mar. 27, 2013 (CN) 201310102289.3

(51) Int. Cl. H04N 7/173

(52) U.S. Cl. CPC H04N 7/17309
USPC 725/115

(57) ABSTRACT

A method and system for synchronized video playing across multiple user terminals are disclosed. The method includes sending a continued video playing request to a server from a first user terminal to play a video from a break point, receiving video information from the server, the video information being submitted from a second user terminal, and playing the video from the break point based on the received video information. The method and system consistent with the present disclosure may improve a user's video watching experience by enabling a user to seamless switch between different user terminals.

### CROSS-REFERENCES TO RELATED APPLICATIONS

### Related Applications

This application is a continuation application of PCT Patent Application No. PCT/CN2013/086619, filed on Nov. 6, 2013, which is based upon and claims the benefit of priority from Chinese Patent Application No. 201310102289.3, filed on Mar. 27, 2013, the entire contents of all of which are incorporated herein by reference.

### FIELD OF THE INVENTION

The present invention relates to Internet browser technologies and, more particularly, to methods and systems for synchronized video playing across multiple terminals.

### BACKGROUND

With the development of Internet technologies, users often use multiple terminal devices to browse the Internet. A user may have a tablet, a srnartphone, and a network TV, which can all be used to browse the Internet. When a user moves from one terminal device, such as a tablet, to another terminal device, such as a smartphone, the system often needs to reload the webpage. When there is a video file embedded in the webpage, the system n may not be able to continue to play the video file from where the user stopped watching previously on a terminal device. For example, a user may watch a movie on a smartphone. The user may have watched over half of the movie. The user may then move to his Personal Computer (PC) to watch the rest of the movie. The current video playing systems would reload the webpage with the video file of the movie onto the PC. The user may manually select where to start playing the movie on the PC. Such manual operations, however, are not accurate, may cause delay in the video playing process, and may consume significant network resources.

The disclosed method and system are directed to solve one or more problems set forth above and other problems.

### BRIEF SUMMARY OF THE DISCLOSURE

Embodiments consistent with the present disclosure provide a method, system, terminal device, or a server for synchronized video playing across multiple terminals. Embodiments consistent with the present disclosure improve the user experience for watching videos online.

One aspect of the present disclosure provides a method for synchronized video playing across multiple user terminals. The method includes sending a continued video playing request to a server from a first user terminal to play a video from a break point; receiving video information from the server, the video information being submitted from a second user terminal; and playing the video from the break point based on the received video information.

Another aspect of the present disclosure provides a method for synchronized video playing across multiple user terminals. The method includes receiving video information from a second user terminal, the video information being related to a video file; storing the video information received from the second user terminal; and receiving a continued video playing request from a first user terminal. The method further includes sending the video information to the first user terminal so that the first user terminal can play the video from where the second user terminal stopped playing the video.

Another aspect of the present disclosure provides a user terminal used in a synchronized video playing system. The user terminal includes a video information obtaining module configured to send a continued video playing request to a server from a first user terminal to play a video from a break point; and to receive video information from the server, the video information being submitted from the user terminal. The user terminal further includes a video playing module configured to play the video from the break point based on the received video information.

Another aspect of the present disclosure provides a server in a synchronized video playing system. The server includes a video information storage module configured to receive video information from a second user terminal, the video information being related to a video file, and store the video information received from the second user terminal; and a video information delivery module configured to receive a continued video playing request from a first user terminal and send the video information to the first user terminal so that the first user terminal can play the video file from where the second user terminal stopped playing.

Embodiments consistent with the present disclosure enable a user to watch a video seamlessly across multiple terminals. The embodiments consistent with the present disclosure thus effectively synchronize the video playing process across multiple terminals. The embodiments consistent with the present disclosure improve the user experience for watching video online.

Other aspects of the present disclosure can be understood by those skilled in the art in light of the description, the claims, and the drawings of the present disclosure.

### BRIEF DESCRIPTION OF THE DRAWINGS

To illustrate embodiments of the invention, the following are a few drawings illustrating embodiments consistent with the present disclosure.

FIG. 1 is a flowchart of a method for synchronized video playing implemented by an exemplary embodiment consistent with the present disclosure;

FIG. 2 is another flowchart of a method for synchronized video playing implemented by an exemplary embodiment consistent with the present disclosure;

FIG. 3 is a schematic diagram of an exemplary apparatus for synchronized video playing consistent with the present disclosure;

FIG. 4 illustrates an exemplary operating environment incorporating certain disclosed embodiments; and

FIG. 5 illustrates a block diagram of an exemplary computer system consistent with the disclosed embodiments.

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiment, persons of ordinary skill in the art may derive other embodiments consistent with the present disclosure, all of which are within the scope of the present invention.

In embodiments consistent with the present disclosure, a user may use a first user terminal to log into an account to watch a video on a webpage. A user terminal may be referred to as a terminal or a terminal device. A user terminal may be any computing device with capacity to connect to a network, such as a network TV or a smartphone. The user may stop the video and request that the synchronized video playing system record the break point, i.e. where the video is stopped. A break point may be an indicator of time or any other indicator (e.g. percentage of data in a file) for a position in an audio or video file. A break point may also be a combination of indicators pointing to a position in a video or audio file. A server may receive the user's request and record the break point of the video. The user may later use a second user terminal to log into the account to continue to watch the video. The synchronized video playing system may then continue to play the video from the break point.

Embodiments consistent with the present disclosure may be implemented for seamlessly watching video, listening to music, or playing a computer game across multiple user terminals. Although the video watching scenarios are used in the examples below, it is apparent that the present disclosure can also be applied to playing other large files over a period of time.

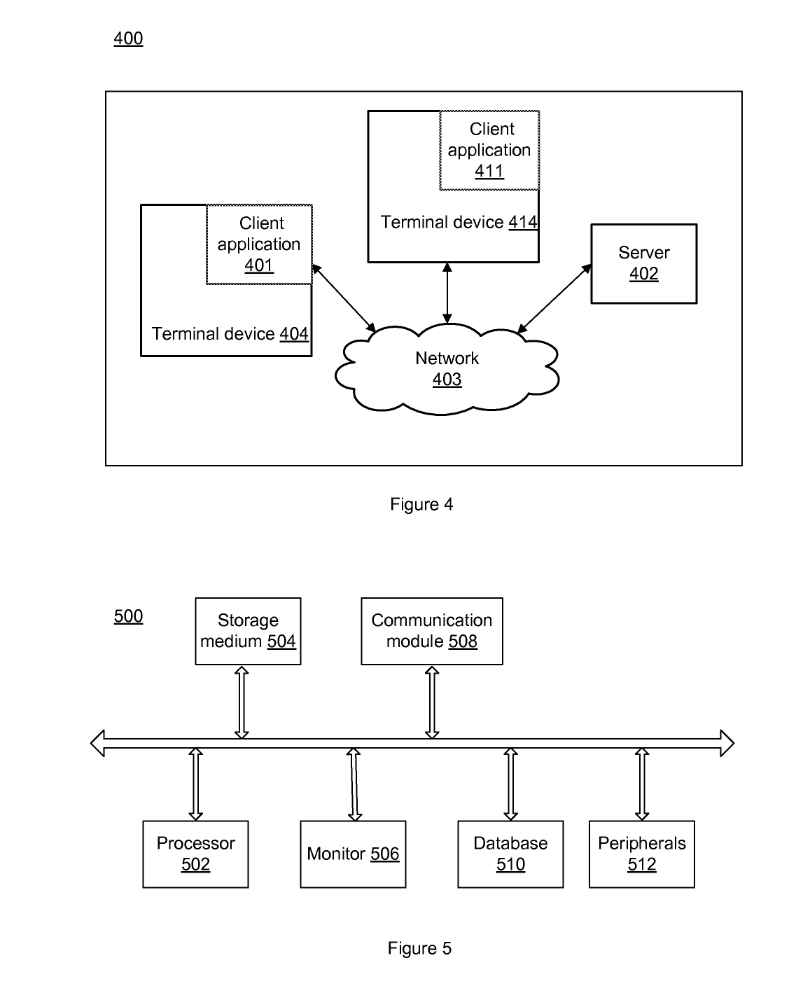

FIG. 4 illustrates an exemplary online computer environment 400 incorporating certain disclosed embodiments. As shown in FIG. 4, environment 400 may include terminal devices 404 and 414, a network 403, and a server 402. The network 403 may include any appropriate type of communication network for providing network connections to the terminal devices 404 and 414, and the server 402. For example, network 403 may include the Internet, LAN (Local Area Network), or other types of computer networks or telecommunication networks, either wired or wireless.

A server, as used herein, may refer to one or more server computers configured to provide certain functionalities, which may require any user accessing the services to authenticate to the server before the access. A server may also include one or more processors to execute computer programs in parallel. The server 402 may include any appropriate server computers configured to provide certain server functionalities, such as storing information related to video playing submitted by a user. Although only one server is shown, any number of servers can be included. The server 402 may operate in a cloud or non-cloud computing environment.

Terminal devices 404 and 414 may include any appropriate type of network computing devices, such as PCs, tablets, smartphones, network TVs, etc. Terminal devices 404 and 414 may include one or more client applications 401 and 411. The client applications 401 and 411, as used herein, may include any appropriate software application, hardware application, or a combination thereof to achieve certain client functionalities. For example, client applications 401 and 411 may be a browser such as Internet Explorer or Firefox with plugins to play various video files. Any number of client applications 401 and 411 may be included in the environment 400.

In one embodiment, the terminal device 404 may connect to a server 402 to upload or download data. A user may use client application 401 to browse the Internet page, play a music file, or watch a video file. In one example, the terminal device 414, through application 411, may continue to watch a video that was previously watched on the terminal device 404. The server 402 may determine where the user stopped the video playing on the terminal device 404 (break point) and then continue to play the video file form the break point on terminal device 414.

Terminal devices 404/414 and server 402 may be implemented on any appropriate computing platform. FIG. 5 illustrates a block diagram of an exemplary computer system 500 capable of implementing terminal devices 404/414 and server 402.

As shown in FIG. 5, computer system 500 may include a processor 502, storage medium 504, a monitor 506, a communication module 508, a database 510, and peripherals 512. Certain devices may be omitted and other devices may be included.

Processor 502 may include any appropriate processor or processors. Further, processor 502 can include multiple cores for multi-thread or parallel processing. Storage medium 504 may include memory modules, such as Read-only memory (ROM), Random Access Memory (RAM), flash memory modules, and erasable and rewritable memory, and mass storages, such as CD-ROM, U-disk, and hard disk, etc. Storage medium 504 may store computer programs for implementing various processes, when executed by processor 502.

Further, peripherals 512 may include I/O devices such as keyboard and mouse, and communication module 508 may include network devices for establishing connections through the communication network. Database 510 may include one or more databases for storing certain data and for performing certain operations on the stored data, such as database searching.

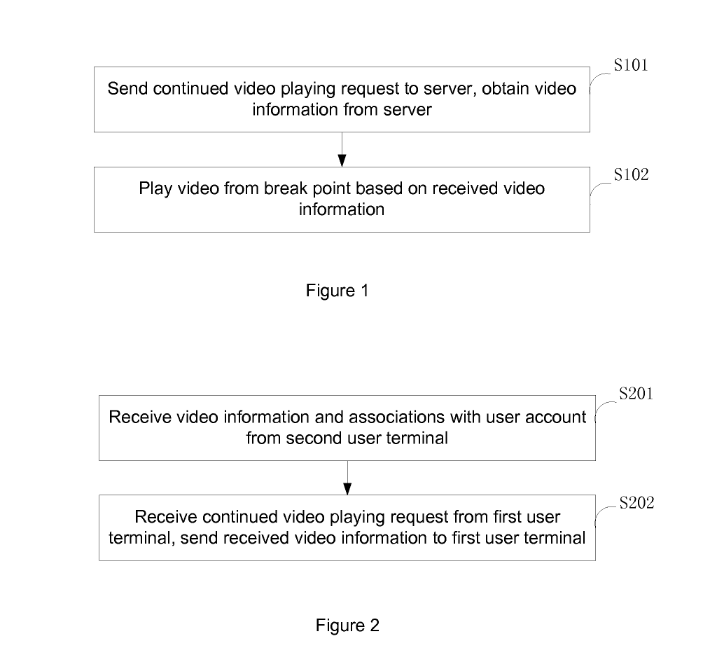

In operation, the terminal device/client application 404/401 may submit to or retrieve data supporting synchronized video playing from server 402. FIG. 1 shows a flow chart of a method for synchronized video playing implemented by embodiments consistent with the present disclosure. As discussed in relation to FIGS. 4 and 5 above, a system for synchronized video playing implementing such a method may include one or more user terminal devices and one or more servers implementing synchronized video playing functions. The terminal devices may also be referred to as user terminals. The method shown in FIG. 1 includes steps S101-S102.

Before step S101, a user may use a second user terminal to log into an account to watch a video from a webpage. The account may be any account for online services, such as an instance message account. The webpage with an embedded video file may be any webpage presented in a browser that contains the functions to play a video file. The user may then send a delayed video playing request to the synchronized video playing system. The browser may include video information associated with this video in the request.

The video information may include information reflecting a link to a webpage containing the video file, a break point, and playback parameters from previous video playbacks. The video information may be the information associated with one or more webpages containing video files. The video information may be associated with a user account and may be stored on the server. The break point may refer to the point at which the video was stopped on a webpage. The playback setting parameters include, but are not limited to, video resolution, screen ratio, and background light settings. The playback parameters were used by the user to play the video.

The delayed video playing request may trigger the browser to obtain the video information associated with the current video. In the case that multiple instances of the browser are running on a user terminal, the synchronized video playing system may obtain the video information from one of the instances, and send the video information to the server.

In step S101, a user may use a browser of a first user terminal to log into the account, which contains a webpage with a video file embedded. The account may be any account for online services, such as an instance message account. The webpage with an embedded video file may be any webpage presented in a browser that contains the functions to play a video file. In the present disclose, “first” and “second” are used to refer to different user terminals or different instances of one terminal. They do not imply sequence or limit the scope of the disclosure.

The user may send a continued video playing request to the synchronized video playing system. The continued video playing request may be any request sent by the browser to a server that requests the server to continue to play a video file. The server may continue to play a video file based on video information such as the break point associated with the video file previously uploaded by the user. The browser of the first user terminal may send the continued video playing request to the server. The server may obtain the video information associated with the user account.

In step S102, the first user terminal may receive the video information from the server and continue to play the video based on the video information. In this example, playing the video on the first user terminal based on video information may include the following steps. The browser of the first user terminal may open the webpage based on the link in the video information. The browser may then set the playback parameters based on the playback parameters in the video information. The browser may further download the video file from the break point identified in the video information and continue to play the video.

In this example, the webpage link included in the video information corresponds to only one video file. Embodiments consistent with the present disclosure enable the user to seamlessly watch a video from different user terminals or at different times.

The following is another exemplary embodiment implementing the method as described in FIG. 1, in which a user watches a movie using a smartphone and a PC. First, the user may log into an instant message account “zhangX” at the QQ instant message browser on a smartphone. The user may watch a movie in the browser. When the movie has played to the 45:30 (45 minutes 30 seconds) point, the user may wish to switch to watch the movie on a PC. The user may send a delayed video playing request from the QQ browser to the server. The QQ browser may include the video information associated with this movie, such as the link to the webpage, the break point, video playback parameters, in the request. The QQ browser may also include the information reflecting the association of the video information to the user account in the request. In this example, the video play back parameters may be: high resolution, screen ratio 4:3, and with backlight on.

The user may log into his QQ account “zhangX” on a PC. Alternatively, the user may add a plug-in into the chrome browser, and log into the instant message account “zhangX.” The user may send a request for continued video playing to the server. The server may obtain the video information received from the smartphone browser and send the video information to the PC's browser. The user may then continue to play the movie in the browser on the PC with high resolution, a screen ratio of 4:3, and the background set with backlight on.

Embodiments consistent with the present disclosure may enable a user to transfer information associated with his account to the server. The embodiments consistent with the present disclosure simplify the operations for playing a video file continuously across multiple user terminals or at different times.

FIG. 2 shows a flow chart for continued video playing implemented by embodiments consistent with the present disclosure. The method includes steps S201-S202.

In step S201, a server of the synchronized video playing system may receive the video information sent by the browser of the second user terminal. The server may store the video information and the associated account information. The video information may include information reflecting a link to a webpage containing the video file, a break point, and playback parameters from previous video playbacks. The video information may be the information associated with one or more webpages containing video files. The video information may be associated with a user account and may be stored on the server. The break point may refer to the point at which the video was stopped on a webpage. The playback setting parameters include, but are not limited to, video resolution, screen ratio, and background light settings. The playback parameters were used by the user to play the video.

In step S202, the server may receive the continued video playing request from the browser of the first user terminal. The server may send the video information associated with the user account to the browser. In this example, the continued video playing request refers to the request sent by the first user terminal to the server, requesting the server to send the video information to the first user terminal. The server may receive the continued video playing request and send the requested video information to the first user terminal.

Alternatively, a server may receive a video complete message from the first or the second terminal. The server may then delete the video information related to the video and the information reflecting the video information's association with the user account. For example, after a user sends a delayed video playing request to the server from a second user terminal, the user may watch the rest of the video from the second user terminal. The user may also continue to watch the video from the first user terminal. Once the user reaches the end of the video file in either terminal, the server may receive a message from the browser indicating that the user has played the whole video. The server may then delete the video information associated with this video and the video information's association with this user account from its storage.

Embodiments consistent with the present disclosure may enable a user to transfer information associated with his account to the server. The embodiments consistent with the present disclosure simplify the operations for playing a video file continuously across multiple user terminals or at different times.

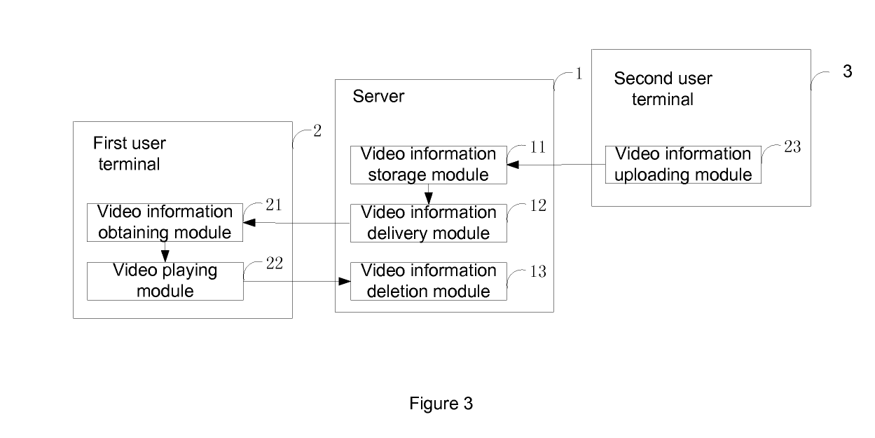

FIG. 3 shows an apparatus for synchronized video playing consistent with the present disclosure. For convenience of description, FIG. 3 only shows the components relevant to the example described below. The apparatus as shown in FIG. 3 includes a server 1, a first user terminal 2, and a second user terminal 3. The server 1 and the user terminals 2 and 3 are connected by a network, such as the Internet. The user terminals 2 and 3 both can play videos.

The second user terminal 3 may include a browser. The browser may send a delayed video playing request to the server 1. The request may contain video information associated with the video played on the second user terminal 3.

The server 1 may receive the video information from the second user terminal 3, and store the video information. The server 1 may then receive a request for continued video playing from the first user terminal 2. The server 1 may send the video information to the first user terminal 2.

The first user terminal 2 may use a browser to log into the user account. The browser may send the request for continued video playing to the server 1. The server 1 may send the video information received from the second user terminal 3 to the browser. The user may then continue to watch the video through the browser on the second user terminal 3.

In another example, the first user terminal 2 may include a video information obtaining module 21, and a video playing module 22. The second user terminal 3 may include a video information uploading module 23.

The video information obtaining module 21 may obtain video information from the server 1. The video information obtaining module 21 may send the continued video playing request to the server 1 to obtain the video information the server 1 received from the second user terminal 3. The video playing module 22 may play the video based on the video information received from the server 1.

The video information may include information reflecting a link to a webpage containing the video file, a break point, and playback parameters from previous video playbacks. The video information may be the information associated with one or more webpages containing video files. The video information may be associated with a user account and may be stored on the server. The break point may refer to the point at which the video was stopped on a webpage. The playback setting parameters include, but are not limited to, video resolution, screen ratio, and background light settings. The playback parameters were used by the user to play the video.

The video information obtaining module 21 of the first user terminal may open the webpage based on the link in the video information. The video information obtaining module 21 may then set the playback parameters based on the playback parameters in the video information. The video information obtaining module 21 may further download the video file based on the break point identified in the video information and continue to play the video.

The video information uploading module 23 of the second user terminal 3 may obtain video information from a browser of the second user terminal 3 and send the video information to the server 1.

Further, in FIG. 3, the server 1 may include a video information storage module 11, a video information delivery module 12, and a video information deletion module 13. The video information storage module 11 may receive video information and its association with the user account from the second user terminal 3, and store the video information and the association information in the storage. Video information delivery module 12 may receive the continued video playing request from the first user terminal 2, and send the requested video information to the browser of the first user terminal 2. The video information deletion module 13 may delete video information and the related association information based on the video complete message received from the first user terminal 2 or the second user terminal 3.

The apparatus as described in FIG. 3 can be used to implement the methods shown in FIGS. 1 and 2. The details of such implementations are disclosed in relation to FIGS. 1 and 2, and will not be repeated here.

Consistent with embodiments of the present disclosure, one or more non-transitory storage medium storing a computer program are provided to implement the system and method for synchronized video playing across multiple terminals. The one or more non-transitory storage medium may be installed in a computer or provided separately from a computer. A computer may read the computer program from the storage medium and execute the program to perform the methods consistent with embodiments of the present disclosure. The storage medium may be a magnetic storage medium, such as hard disk, floppy disk, or other magnetic disks, a tape, or a cassette tape. The storage medium may also be an optical storage medium, such as optical disk (for example, CD or DVD). The storage medium may further be semiconductor storage medium, such as DRAM, SRAM, EPROM, EEPROM, flash memory, or memory stick.

Other embodiments of the disclosure will be apparent to those skilled in the art from consideration of the specification and practice of the invention disclosed herein. It is intended that the specification and examples be considered as exemplary only, with a true scope and spirit of the invention being indicated by the claims.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and systems, various systems for playing video over multiple terminals may be implemented. For example, a user may watch a movie on a first user terminal device. The user may stop the movie and send a delayed video playing request to the server. The delayed video playing request may include video information such as information indicating the break point of the movie, and the webpage from which the movie was played. The user may continue to watch the movie a few days later. The user may send a continued video playing request to the server to retrieve the video information. The user may then download the part of movie from the break point to the end (instead of the whole movie) and continue to watch the movie from the break point. Once the user finishes the movie, the browser may send the server a message indicating that the movie has been played to the end. The server may then delete the video information received before. By recording and later retrieving the video information, the synchronized video playing system delivers a seamless video watching experience across different time periods and saves network resources.

What is claimed is:

1. A method for synchronized video playing across multiple user terminals, comprising:
sending a continued video playing request to a server from a first user terminal to play a video file from a break point;
receiving video information from the server, the video information being submitted from a second user terminal; and
playing the video from the break point based on the received video information.

2. The method according to claim 1, wherein the video information includes a link to a webpage with access to the video file, the break point in the video file, and video playing parameters.

3. The method according to claims 2, the method further comprising:
opening up the link to the webpage;
downloading the video file from the break point on; and
playing the video file from the webpage using the video playing parameters.

4. The method according to claim 3, the method further comprising:
logging into a user account from the second user terminal;
obtaining the video information from a browser of the second user terminal;
sending a request for delayed video playing from the second user terminal to the server, the request including the video information;
logging into the user account from the first user terminal; and
obtaining, by the first user terminal, the video information from the server.

5. A method for synchronized video playing across multiple user terminals, comprising:
receiving video information from a second user terminal, the video information being related to a video file;
storing the video information received from the second user terminal;
receiving a continued video playing request from a first user terminal; and
sending the video information to the first user terminal so that the first user terminal can play the video from where the second user terminal stopped playing the video.

6. The method according to claim 5, further comprising:
receiving a message indicating the first user terminal or the second user terminal has finished playing the video; and
deleting the video information from the server.

7. A user terminal used in a synchronized video playing system, comprising:
a video information obtaining module configured to send a continued video playing request to a server from a first user terminal to play a video from a break point and receive video information from the server, the video information being submitted from a second user terminal; and
a video playing module configured to play the video from the break point based on the received video information.

8. The user terminal according to claim 7, wherein the video information includes a link to a webpage with access to the video file, the break point in the video file, and video playing parameters.

9. The user terminal according to claim 8, wherein the video playing module is further configured to open up the link to the webpage, download the video from the break point on, and play the video from the webpage using the video playing parameters.

10. The user terminal according to claim 9, wherein the video information obtaining module is further configured to log into a user account, and to obtain the video information from a browser of the second user terminal.

11. The user terminal according to claim 10, further comprising:
a video information uploading module configured to send a request for delayed video playing from the user terminal to the server, the request including the video information.

12. A server in a synchronized video playing system, comprising:
a video information storage module configured to receive video information from a second user terminal, the video information being related to a video file, and store the video information received from the second user terminal; and
a video information delivery module configured to receive a continued video playing request from a first user terminal and send the video information to the first user terminal so that the first user terminal can play the video from where the second user terminal stopped playing the video.

13. The server according to claim 12, further comprising:
a video information deletion module configured to receive a message indicating the first user terminal or the second user terminal has finished playing the video file, and to delete the video information from the server.

14. The server according to claim 13, wherein the video information includes a link to a webpage with access to the video file, a break point in the video file, and video playing parameters.

15. The server according to claim 14, wherein the break point indicates where the second user terminal previously stopped playing the video.
